(19) United States
(12) Patent Application Publication
(10) Pub. No.: US 2013/0232795 A1
(43) Pub. Date: Sep. 12, 2013

(54) TOOL FOR REMOVING SCRATCH-OFF COATINGS

(71) Applicant: Paul Sista, Clifton, NJ (US)

(72) Inventor: Paul Sista, Clifton, NJ (US)

(21) Appl. No.: 13/798,051

(22) Filed: Mar. 12, 2013

Related U.S. Application Data
(60) Provisional application No. 61/609,785, filed on Mar. 12, 2012.

(51) Int. Cl. B26B 1/08

(52) U.S. Cl. CPC B26B 1/08
USPC 30/162

(57) ABSTRACT

A tool has a retractable blade designed for removing scratch-off coatings, such as those that reveal activation codes on gift cards, without causing damage to the printing under the scratch-off coating. Unlike conventional objects, such as knifes and coins, the tool of the present invention removes only the scratch-off coating without scraping off the activation code. The blade can be extended from and retracted into a tool body, typically through the use of a locking slider. The tool body can have a receptacle for insertion of a key ring, providing ready access on a user's key chain, for example.

### CROSS-REFERENCE TO RELATED APPLICATION

This application claims the benefit of priority of U.S. provisional application No. 61/609,785, filed Mar. 12, 2012, the contents of which are herein incorporated by reference.

### BACKGROUND OF THE INVENTION

The present invention relates to hand tools and, more particularly, to a tool for removing scratch-off coatings, such as those on gift cards that reveal a need code for activation.

To activate i-tune, gift cards, and the like, the recipient needs to scrap off a coating to reveal a code. Most people use a coin or sharp object to remove the scratch-off coating. However, this can damage the printing beneath the scratch-off coating, making the activation code impossible to read. This can result in a card that is valueless.

As can be seen, there is a need for an apparatus for removing scratch-off coatings, such as those found on gift cards and the like.

### SUMMARY OF THE INVENTION

In one aspect of the present invention, a tool comprises a tool body; a blade opening disposed on one end of the tool body; a blade movable to extend out of the blade opening and retract into the tool body, the blade having a non-sharpened periphery operable to remove a scratch-off coating without damaging a substrate covered by the scratch-off coating; a slider slot formed along at least a portion of one side of the tool body; and a slider extending from the slider slot where movement of the slider along the slider slot moved the blade between an extended configuration and a retracted configuration.

In another aspect of the present invention, a tool for removing scratch-off coatings comprises a tool body; a blade opening disposed on one end of the tool body; a blade movable to extend out of the blade opening and retract into the tool body, the blade having a non-sharpened periphery operable to remove a scratch-off coating without damaging a substrate covered by the scratch-off coating; a track formed inside the tool body for movement of the blade therealong; a slider slot formed along at least a portion of one side of the tool body; a slider extending from the slider slot where movement of the slider along the slider slot moved the blade between an extended configuration and a retracted configuration;

two or more slider stops disposed in the tool body; a latch part of the slider that fits into a selected one of the two or more slider stops to keep the blade in either an extended configuration or a retracted configuration; and a spring resiliently retaining the latch part in the selected one of the two or more slider stops.

In a further aspect of the present invention, a method for removing a scratch-off coating from a substrate without damaging the substrate supporting the scratch-off coating comprises depressing a head of a slider extending from a slider slot formed along one side of a tool body to remove a latch part of the slider from a first slider stop within the tool body; pushing the slider toward a blade opening disposed on one end of the tool body to extend a blade out of the blade opening; locking the blade in an extended configuration by allowing the latch part of the slider to engage into a second slider stop within the tool body; and scratching off the scratch-off coating from the substrate to reveal information thereunder.

These and other features, aspects and advantages of the present invention will become better understood with reference to the following drawings, description and claims.

### BRIEF DESCRIPTION OF THE DRAWINGS

FIG. 1 is a perspective view of a tool for removing scratch-off coatings, with its blade extended, according to an exemplary embodiment of the present invention;

FIG. 2 is a perspective view of the tool of FIG. 1, with its blade in a retracted configuration;

FIG. 3 is a cross-sectional view taken along line 3-3 of FIG. 1;

FIG. 4 is a cross-sectional view taken along line 4-4 of FIG. 1; and

FIG. 5 is a perspective view of the tool of FIG. 1, in use to remove a scratch-off coating on a card.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a tool having a retractable blade designed for removing scratch-off coatings, such as those that reveal activation codes on gift cards, without causing damage to the printing under the scratch-off coating. Unlike conventional objects, such as knifes and coins, the tool of the present invention removes only the scratch-off coating without scraping off the activation code. The blade can be extended from and retracted into a tool body, typically through the use of a locking slider. The tool body can have a receptacle for insertion of a key ring, providing ready access on a user's key chain, for example.

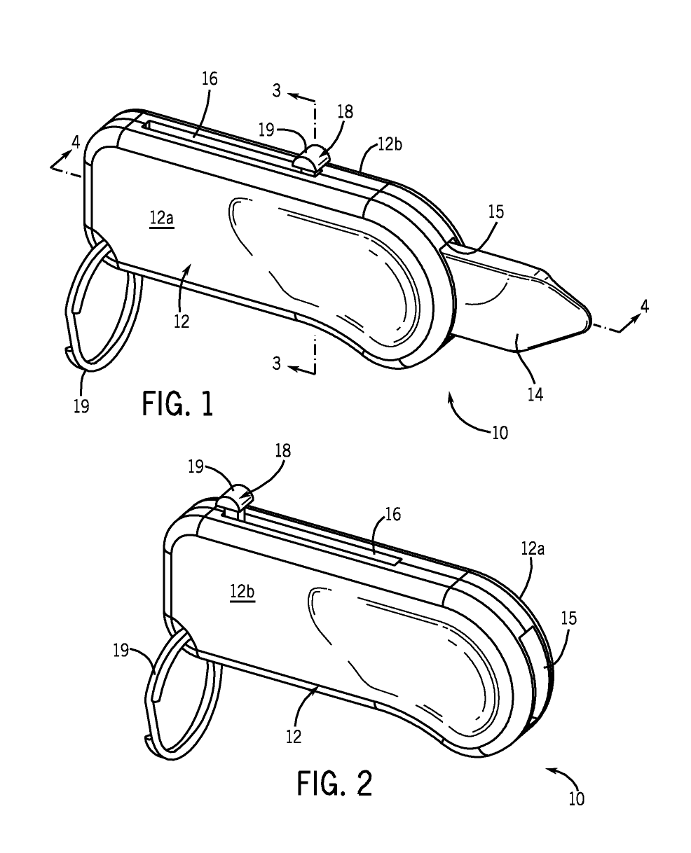

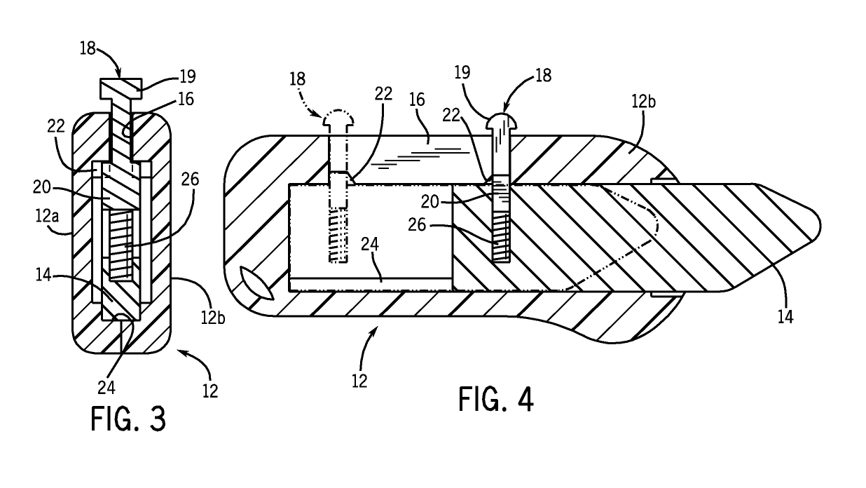

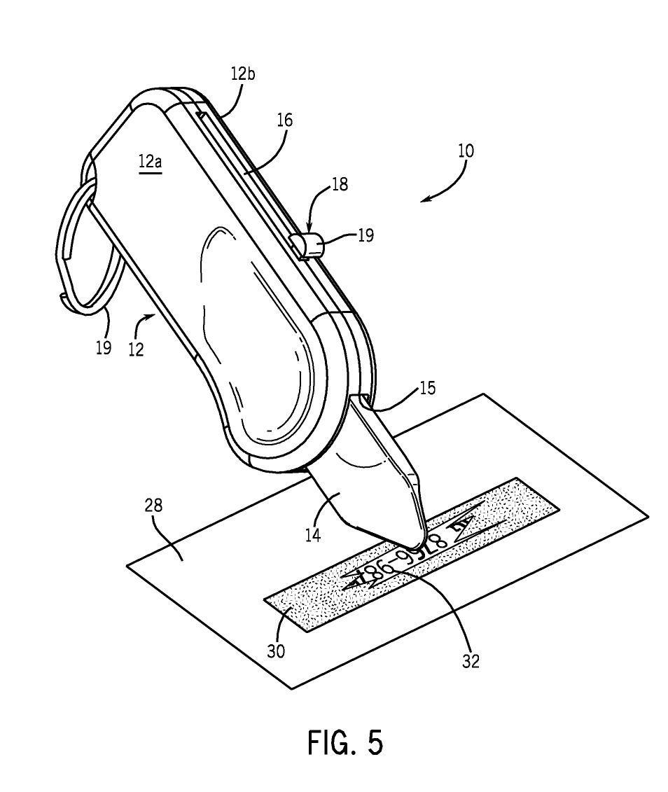

Referring now to FIGS. 1 through 5, a tool 10 for scratching off coatings, such as those on gift cards, phone cards, music cards, lottery tickets, and the like, can include a tool body 12 with an opening 15 from which a blade 14 can be extended out of and retracted back into the tool body 12.

The tool body 12 can be produced from a first half 12a and a second half 12b that can attach together and hold the blade 14 therewithin. A slider slot 16 can be disposed on at least a portion of one side of the tool body 12. A locking slider 18 can extend from the slider slot 16, with a head 19 of the slider 18 being accessible from outside of the tool body. At least two slider stops 22 can be disposed within the tool body 12. The slider 18 can have a spring 26 resiliently pushing a latch part 20 of the slider 18 into the slider stops 22. A user can press on the slider head 19 to push the latch part 20 of the slider 18 out of the slider stop 22. The user can then urge the head 19 to move along the slider slot 16 to slide the blade 14 in and out of the tool body 12. The slider 18 can engage with the blade 14 so that movement of the slider 18 also moves the blade 14 along a blade track 14. When the blade is in an extended configuration (FIGS. 1, 4 and 5), the slider 18 can engage with a slider stop 22 to prevent the blade 14 from being pushed back into the tool body 12 when being used to remove a scratch-off coating 30 to, for example, reveal a code 32 on a card 28, such as a gift card, a phone card, a music card or the like.

The tool body 12 can have a key ring 29 attached thereto to provide easy storage of the tool 10, such as attachment onto a user's key chain.

As shown in FIG. 5, the blade 14 can be used to reveal a code 32, such as an activation code on a card 28 by removing a scratch-off coating 30 from the card 28. The blade 14 is designed to remove only the scratch-off coating 30 without damaging the code 32 or the substrate on which the scratch-off coating 30 is applied. While this Figure shows the tool 10 being used on a card 28 to reveal its code 32, the tool 10 can be used to scrape off any desired scratch-off coating, such as those on instant lottery tickets, for example.

The tool 10 can be made of various materials as may be known in the art. In some embodiments, the tool 10 can be made of plastic.

It should be understood, of course, that the foregoing relates to exemplary embodiments of the invention and that modifications may be made without departing from the spirit and scope of the invention as set forth in the following claims.

What is claimed is:

1. A tool comprising:
a tool body;
a blade opening disposed on one end of the tool body;
a blade movable to extend out of the blade opening and retract into the tool body, the blade having a non-sharpened periphery operable to remove a scratch-off coating without damaging a substrate covered by the scratch-off coating;
a slider slot formed along at least a portion of one side of the tool body; and
a slider extending from the slider slot where movement of the slider along the slider slot moved the blade between an extended configuration and a retracted configuration.

2. The tool of claim 1, further comprising a track formed inside the tool body for movement of the blade therealong.

3. The tool of claim 1, further comprising a mechanism for locking the blade in the retracted configuration or in the extended configuration.

4. The tool of claim 3, wherein the mechanism includes two or more slider stops disposed in the tool body and a latch part of the slider that fits into a selected one of the two or more slider stops to keep the blade in either the extended configuration or the retracted configuration.

5. The tool of claim 4, wherein the slider includes a slider head depressible by the user to move the latch part out of the selected one of the two or more slider stops.

6. The tool of claim 4, further comprising a spring resiliently retaining the latch part in the selected one of the two or more slider stops.

7. A tool for removing scratch-off coatings, comprising:
a tool body;
a blade opening disposed on one end of the tool body;
a blade movable to extend out of the blade opening and retract into the tool body, the blade having a non-sharpened periphery operable to remove a scratch-off coating without damaging a substrate covered by the scratch-off coating;
a track formed inside the tool body for movement of the blade therealong;
a slider slot formed along at least a portion of one side of the tool body;
a slider extending from the slider slot where movement of the slider along the slider slot moved the blade between an extended configuration and a retracted configuration;
two or more slider stops disposed in the tool body;
a latch part of the slider that fits into a selected one of the two or more slider stops to keep the blade in either an extended configuration or a retracted configuration; and
a spring resiliently retaining the latch part in the selected one of the two or more slider stops.

8. The tool of claim 7, wherein the slider includes a slider head depressible by the user to move the latch part out of the selected one of the two or more slider stops.

9. A method for removing a scratch-off coating from a substrate without damaging the substrate supporting the scratch-off coating, the method comprises:
depressing a head of a slider extending from a slider slot formed along one side of a tool body to remove a latch part of the slider from a first slider stop within the tool body;
pushing the slider toward a blade opening disposed on one end of the tool body to extend a blade out of the blade opening;
locking the blade in an extended configuration by allowing the latch part of the slider to engage into a second slider stop within the tool body; and
scratching off the scratch-off coating from the substrate to reveal information thereunder.

10. The method of claim 9, further comprising resiliently moving the slide into one of the first slider stop and the second slider stop with a spring.
